(19) United States
(12) Patent Application Publication
(10) Pub. No.: US 2013/0159740 A1
(43) Pub. Date: Jun. 20, 2013

(54) ELECTRONIC DEVICE AND METHOD FOR ENERGY EFFICIENT STATUS DETERMINATION

(71) Applicants: Johann Zipperer, Unterschleissheim (DE); Marko Krüger, Freising (DE); Markus Kösler, Landshut (DE)

(72) Inventors: Johann Zipperer, Unterschleissheim (DE); Marko Krüger, Freising (DE); Markus Kösler, Landshut (DE)

(73) Assignee: Texas Instruments Incorporated, Dallas, TX (US)

(21) Appl. No.: 13/329,054

(22) Filed: Dec. 16, 2011

(51) Int. Cl. G06F 1/32; G06F 3/00

(52) U.S. Cl. 713/320; 710/19

(57) ABSTRACT

The invention relates to an electronic device and a method for event handling in an electronic device comprising a bus master and a memory for storing a software program. A status of a software and/or hardware module is polled in a polling loop.

The status polling loop is left and a low power mode is entered when the status polling loop is executed a second time. In other words, any second execution of the status polling loop is detected and the execution of the loop is then terminated. An active mode is entered upon a write operation to a first predefined reserved address indicating that information related to the status of the software and/or hardware module arrived.

### FIELD OF THE INVENTION

The invention relates to an electronic device and a method for event handling in an electronic device for energy efficient status determination in embedded microcontroller systems.

### BACKGROUND

In complex embedded microcontroller systems, communication between software and/or hardware elements is required. A typical scenario in embedded applications is the status polling of a system or module status and memory contents. Modules often contain status flags that have to have a certain value before processing can continue, e.g. FIFO-Ready before data can be stored or Data-Received before data can be read. For inter-process communication often semaphores are used for arbitrating access to system resources. In order to check whether the resource can be used a flag has to be checked continuously until it is free. Both examples could be addressed with special logic such as interrupts but often they are not or can not be used. Also users often implement it the easy way and write while loops in which a specific flag is continuously checked. The disadvantage of this solution is that the CPU has to be active all time in order to poll the status flag. In a typical microcontroller the clock network, CPU, busses and memories are active and consume power. Since polling time is often unpredictable those loops can be executed a long time and finally lead to very power inefficient implementations.

The polling of dedicated status bits in an endless loop or a loop that may time out was used in the early times of computing already and is also often used during early evaluation and test states of large software packages. However, this method consumes a lot of power as the commands within the endless loop are executed continuously. Unfortunately, these methods often remain in the release versions of complex software packages, if time to market is ranked higher than low power efficiency of the software program.

In order to avoid polling loops several other mechanisms have been developed. Dedicated hardware interrupts are typically used to indicate hardware events. However, they are also used or rather abused for software cross-communication, but the original purpose of a module is then lost. This method is just a workaround in situations in which dedicated SW interrupts are not available.

Dedicated software interrupts use—as implied by the name—software interrupts. They are also referred to as TRAPs, SWIs, or simply interrupts. Software interrupts are used for inter-process communications (exchange of status between software entities.

A dedicated mailbox is a specific hard wired memory location that is used to cross communicate between software and/or hardware entities executed on different processors (not processes). They have usually a write port at one side a read port at the other side and an interrupt based transaction event exchange system.

Call-back-functions or doorbell-functions are software functions that allow a loose coupling of software-events. The callback function vector is most often stored in a random access memory (RAM). Therefore, a mounting is to be performed each time the software is re-started/re-initialized.

Semaphore memory elements are memory elements that are accessed (mutually exclusively) using special locked memory methods. They are either supported by the instruction set, a hardware lock mechanism or inside the highest non-maskable interrupt service routine that prevents re-entrance.

Interlocked memory accesses exist in specific architectures. A specific read access to one processor is to be paired with a write access to another processor (e.g. LDII/STII pair).

One disadvantage of most of the prior art solutions is the complexity and the large amount of changes needed, if any original software program uses, for example polling mechanisms and has to be adapted to any of the other previously mentioned mechanism.

Furthermore, an interrupt always “interrupts” the program flow and requires to execute interrupt service routine. The time and power for executing the interrupt service routine is always lost, even if a required status of a module is already reached.

### SUMMARY

It is an object of the invention to provide an electronic device and a method for acquiring status information of software and/or hardware modules in a more power efficient manner and to which existing hardware and software solutions can easily be adapted.

In an aspect of the invention, an electronic device comprising a bus master and a memory for storing a software program is provided. The bus master can be a central processing unit (CPU), a direct memory access controller (DMA) or any other similar instance. The electronic device can be any programmable electronic device, as, for example a microcontroller, an embedded microcontroller system or the like. The software program is configured to acquire a status of a software and/or hardware module. The electronic device can further be configured to enter a status polling loop for determining the status of the software and/or hardware module. According to this aspect of the invention, the electronic device is further configured to leave the status polling loop for entering a low power mode, when the software program executes the status polling loop a second time. Furthermore, the electronic device is advantageously configured to enter an active mode upon a write operation to a first predefined reserved memory address or memory section indicating that information related to the status of the software and/or hardware module arrived. The electronic device comprises a polling stage for detecting that the status polling loop is executed a second time.

In other words, a dedicated new or reused circuit can be used to either monitor memory accesses or to actively poll memory and/or register content. This circuit combined with a sleep and wakeup logic for the electronic device (for example the central processing unit (CPU)) can watch out for events and wake up the electronic device if needed. Furthermore, code generation tools, as for example compilers (with proper options) can automatically transform polling loops (for example “while”-loops) into commands that enable this special logic. Eventually, the result will be the same as with prior art polling loops but with much less power consumption. The aspects and embodiment of the invention show a hardware apparatus that allows maintaining the methods of existing software modules, while reducing the required power for operation to a high degree. The aspects of the invention therefore allow a migration of existing software to the low power environment with little to no change. The advantages reflect in “faster time to market”, lowering risks” and “lowering development costs”. The aspects of the invention are also beneficial for peripheral handling with inherited software stacks that are difficult to change. Other application areas are operating systems with their specific software communication methods. The invention is applicable and useful wherever complex software methods are to be migrated from existing conventional versions to a new low and ultra low power world. Of course new software can also be written with this new method in mind.

The polling loop can then contain a dedicated instruction (herein referred to as “event indication instruction” or EEST_ind) for determining the second execution of the polling loop. The instruction can be inserted into any existing software code. This allows any existing software code to be easily updated. The event indication instruction can provide that the electronic device is put into a low power mode. This low power mode primarily provides that the central processing unit stops executing the endless loop while waiting for the status information. The central processing unit is then in a wait state in which it does not consume power until an access to a restricted section of the memory occurs. Only then the central processing unit resumes normal operation in an active mode.

The polling stage can be configured to determine whether the dedicated instruction came from the same address or address range during the first and the second execution of the loop. This aspect of the invention provides that the electronic device ensures that the instruction was called from exactly the same loop and not from a different loop.

In another aspect of the invention, a second reserved address or memory section is used as a polling address or polling address range. An auto poll indication may then be triggered when the polling range is entered. This aspect provides that the low power mode is entered by detecting an address. This aspect can be used in addition or as an alternative to the event indication instruction.

The reserved memory sections for the polling range and for the event flags can be limited and defined by an upper and lower address. The polling stage can then monitor any access to either of the reserved memory ranges and react appropriately.

The polling stage can be a state machine comprising a test-logic or compare-logic. This is a simple implementation that may even already exist in the electronic device for other purposes.

The polling stage can be set up by the central processing unit. The polling stage can then receive an address that is to be checked. Furthermore, the polling stage can have a test-mask or a compare-value for checking the address.

The central processing unit can then execute a command that provides that it enters a wait-state, when the polling loop is executed the second time. Entering the wait-state advantageously and simultaneously makes the CPU sensitive to react on specific events that are received from the polling stage. The polling stage can then begin reading and continuously read the received addresses (for example addresses present on a bus) and compare and/or test the address values with the give address or address range. Once the compare and/or test result matches a specific expected result, the polling stage sends out a signal to the central processing unit.

The polling address range (or interval) could be fix or configurable. Registers may be used for defining the polling range. If an access to this reserved address range or a reserved address is made, the electronic device enters the low power mode. The polling stage does not actively poll but observes address and/or data on the bus (or memory controller inputs). If a comparison matches a predefined criteria, it sends an event to the bus master (CPU, DMA etc). In the low power mode, the bus master could still react on interrupts but will always return into the low power mode after having performed the interrupt service routines. Only if the required event signal is received, the bus master will continue processing in active mode.

In an embodiment of the invention, the polling stage may be configured to respond to write access. The polling stage may then not always (continuously) compare or test the full address value. Only if a write access occurs, it may wake up the bus master (CPU, DMA etc). The bus master may then check the full address value. If the address value matches the criteria, the electronic device enters active mode. If the criteria are not matched, the trigger is deactivated and the bus master returns to low power mode. This also can substantially reduce clock network, bus and CPU activity.

The polling stage or polling stages according to the invention can be implemented once or multiple times in an electronic device. The polling stage or stages can be coupled to the main bus—e.g. CPU data port or dedicated master module where it has access to all entities or instances. The polling stage can be coupled to bus-slave inputs, for example to a memory controller, where it only has access to local memory (RAM and Peripheral checker are usually sufficient).

The invention also relates to a method of event handling in an electronic device comprising a bus master and a memory for storing a software program. A status of a software and/or hardware module is polled in a polling loop. The status polling loop is left and a low power mode is entered when the status polling loop is executed a second time. In other words, any second execution of the status polling loop is detected and the execution of the loop is then terminated. An active mode is entered upon a write operation to a first predefined reserved address indicating that information related to the status of the software and/or hardware module arrived.

### BRIEF DESCRIPTION OF DRAWINGS

Further aspects and characteristics of the invention will ensue from the following description of the preferred embodiments of the invention with reference to the accompanying drawings, wherein

FIG. 1 shows a simplified diagram illustrating a polling routine according to the prior art;

FIG. 2 shows a simplified diagram illustrating the polling routine with energy efficient status testing according to an embodiment of the invention;

FIG. 3 shows a simplified diagram illustrating the polling routine with energy efficient status testing according to another embodiment of the invention;

FIG. 4 shows a simplified block diagram and circuit diagram of an electronic device according to an embodiment of the invention, and

FIG. 5 shows a simplified diagram illustrating further aspects of the invention.

### DETAILED DESCRIPTION OF AN EXAMPLE EMBODIMENT

A typical example of a polling routine may have the following general form when given in a pseudo-software code:

...
while (line==high)
{ }
wend;
while (line==low)
{ }
wend;
...
...

The above pseudo-code is a simple example for a software implemented wait for a “low to high” transitions on the signal “line”. As soon as either of the loops is run the second time, this constitutes a waste of power. If a change of the signal “line” would generate a hardware-interrupt, the above described interrupt method could be applied to save power. However, this would require a change of the pseudo-code.

The aspects of the invention avoid the drawbacks of the prior art mechanisms. The following pseudo-code shows illustrates, the difference, if the invention is applied to the above polling routine.

...
while (line==high)
{EEST_ind;}
wend;
while (line==low)
{EEST_ind;}
wend;
...
..

Instead of changing the software, a new instruction or macro referred to as event indication instruction “EEST_ind” can be added inside the bodies of the loops. It is further assumed that the module that provides the signal “line” also generates interrupts whenever a change occurs at the “line” signal. In this embodiment of the invention, the system will be put in low power mode, whenever EEST_ind is executed the second time in either of the loops. Upon a change of the “line” signal, the system enters active mode again and continues as usual. This means that no event is missed.

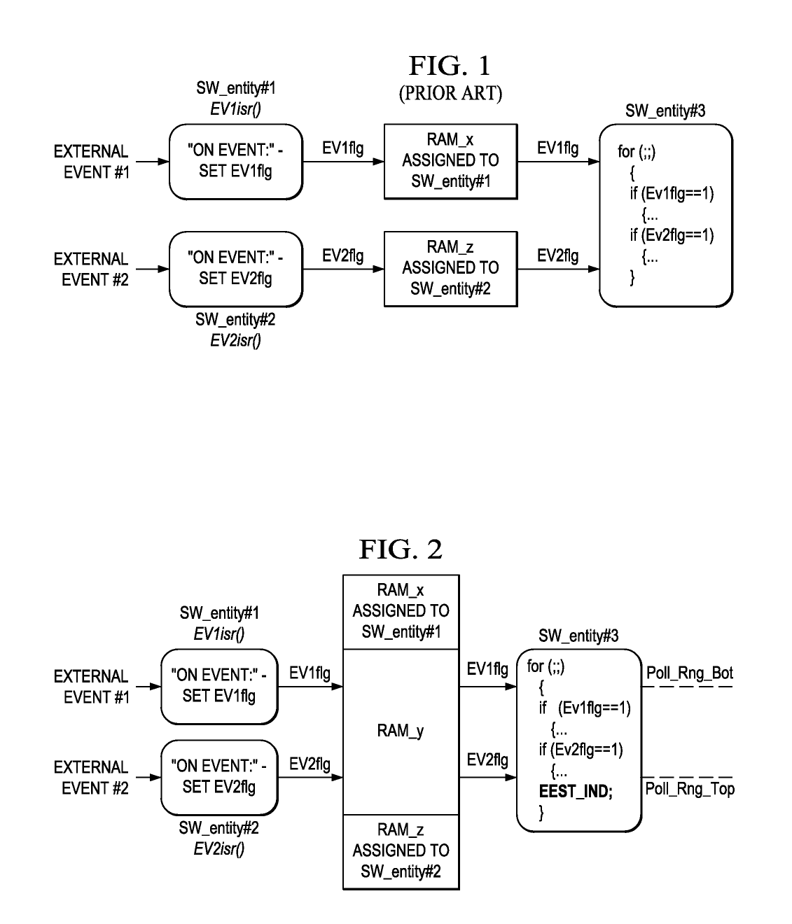

FIG. 1 shows a simplified diagram illustrating a polling routine according to the prior art. SW_entity#1 and SW_entity#2 are “interrupt service routines” that notify the presence of external event#1 and external event#2 by setting the flags Ev1flg and Ev2flg. The SW_entity#3 is polling Ev1flg and Ev2flg continuously for event indications and performs a corresponding operation in case of events. SW_entity#3 has to poll the flags continuously and consumes power. Changing the structure of the software requires a re-layout of the internal dependencies of all involved routines. As previously illustrated, it is also apparent in this case that any further execution of the loop after having run the loop for the first time is a waste of power.

An external event has to happen before Ev1flg or Ev2flg can be set. The external events #1 and #2 can be hardware events or software driven events that are triggered by other events upstream of the event chain.

FIG. 2 shows a simplified diagram illustrating the polling routine with energy efficient status testing according to an embodiment of the invention. In this embodiment of the invention, a reserved address or section or range of a memory is used for waking up the central processing unit once it entered the low power mode. The low power mode can also be considered a sleep or wait mode. The execution of the software program is suspended in this low power mode and the central processing unit waits for an event. This event relates to status information from a hardware or software module. The central processing unit can leave the low power mode when the event occurs (i.e. the status information arrives) or for executing interrupts.

The event flags which are set in response to the external events #1 and #2 are written to a reserved part of the memory referred to as RAM_y. If a writing operation is performed within the address range of RAM_y being reserved for the event flags Ev1flg and Ev2flg, the electronic device leaves the low power mode and changes to active mode. The other memory ranges RAM_x and RAM_z are assigned to the two software entities SW_entity#1 and SW_entity#2.

In this embodiment, the existing set of software routines is not changed. Only the third software routine SW_entity#3 is extended and supplemented by the new instruction EEST_IND. This instruction constitutes the loop indication for the EEST-hardware. The instruction is advantageously placed in the topmost loop in case of a nested polling scheme. The memory locations Ev1flg and Ev2flg have been placed into a dedicated memory section RAM_y that is observed for write accesses. If EEST_IND is executed the second time by executing the loop in the partial system SW_entity#3, the central processing unit is automatically put into a low power mode. A wakeup request is fired as soon as any instance writes to the reserved memory section RAM_y. As there is a write transfer required to communicate an event, it is ensured that no events are missed. The software entities SW_entity#1, SW_entity#2 and SW_entity#3 can be executed by the same or by different central processing units. In distributed systems with split memory architectures only one common memory segment RAM_y can be provided. Only this single part RAM_y of the memory should then be monitored for write accesses.

The electronic device according to this embodiment of the invention comprises a polling stage that is a hardware stage comprising circuitry for implementing the required logic in order to determine whether the same EEST_ind instruction or macro is executed for the second time. The polling stage is also referred to as the EEST-hardware. This EEST-hardware is configured to stop unnecessary looping and polling by observing the address boundaries of the involved code and data elements. There is the upper address limiting the polling range Poll_Rng_Top and the lower address limiting the polling range Poll_Rng_Bot. In an embodiment, a poll range may be specified by setting the “Poll_Rng_Bot” and “Poll_Rng_Top” values in registers. An auto poll indication is triggered as soon the poll range is entered the second time, the low power mode activated. This alternative method comes really handy on complex polling schemes of “foreign SW” that is difficult to analyze.

Extending this assembly of functions is much simpler than changing it for all the other prior art methods. In this embodiment, the events have one source and one sink only. However, in other embodiments, the events may have several sources and sinks.

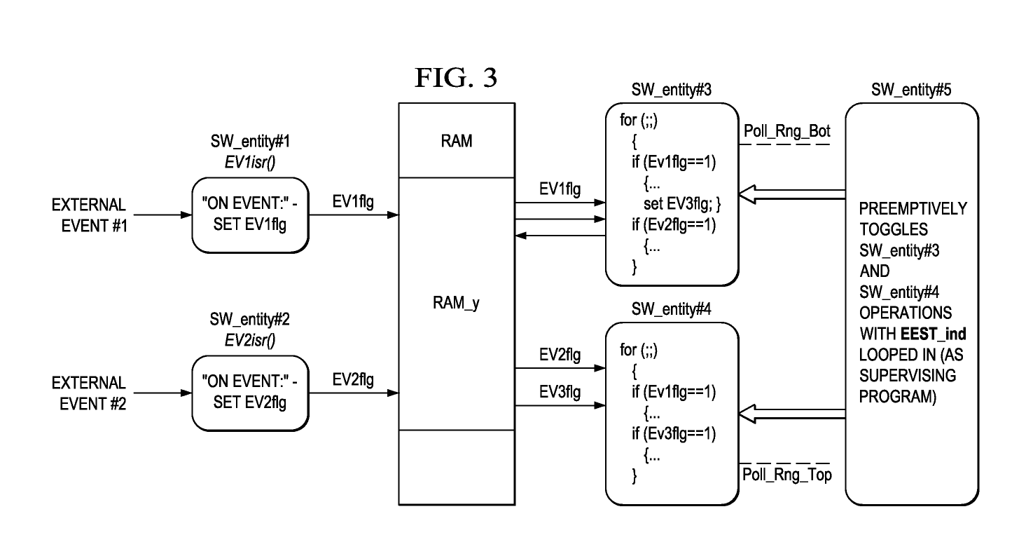

FIG. 3 shows a simplified diagram illustrating the polling routine with energy efficient status testing according to another embodiment of the invention.

In this embodiment, the external event #2 is broadcasted to software entity SW_entity#3 and SW_entity#4. External event #1 is a tributary event for event flag Ev3flg, which is communicated from SW_entity#3 to SW_entity#4. Software entity SW_entity#5 is a supervising instance for software entities SW_entity#3 and SW_entity#4 that alternatively enables the execution of the subordinate software entities SW_entity#3 and SW_entity#4 in a preemptive way. SW_entity#3, SW_entity#4 and SW_entity#5 are running on the same processor mutually exclusive. For this kind of event broadcasting some of the alternative prior art methods described above do not work anymore.

However, the aspects of the present invention can easily be applied to this configuration. All the flags for event propagation are placed in reserved memory section RAM_y. SW_entity#5 that alternatively enables SW_entity#3 and SW_entity#4 operates as a top loop and receives the event instruction EEST_ind. The necessary remaining steps are then performed by the polling stage hardware.

The polling range from Poll_Rng_Bot to Poll_Rng_Top may be put across SW_entity#3 and SW_entity#4.

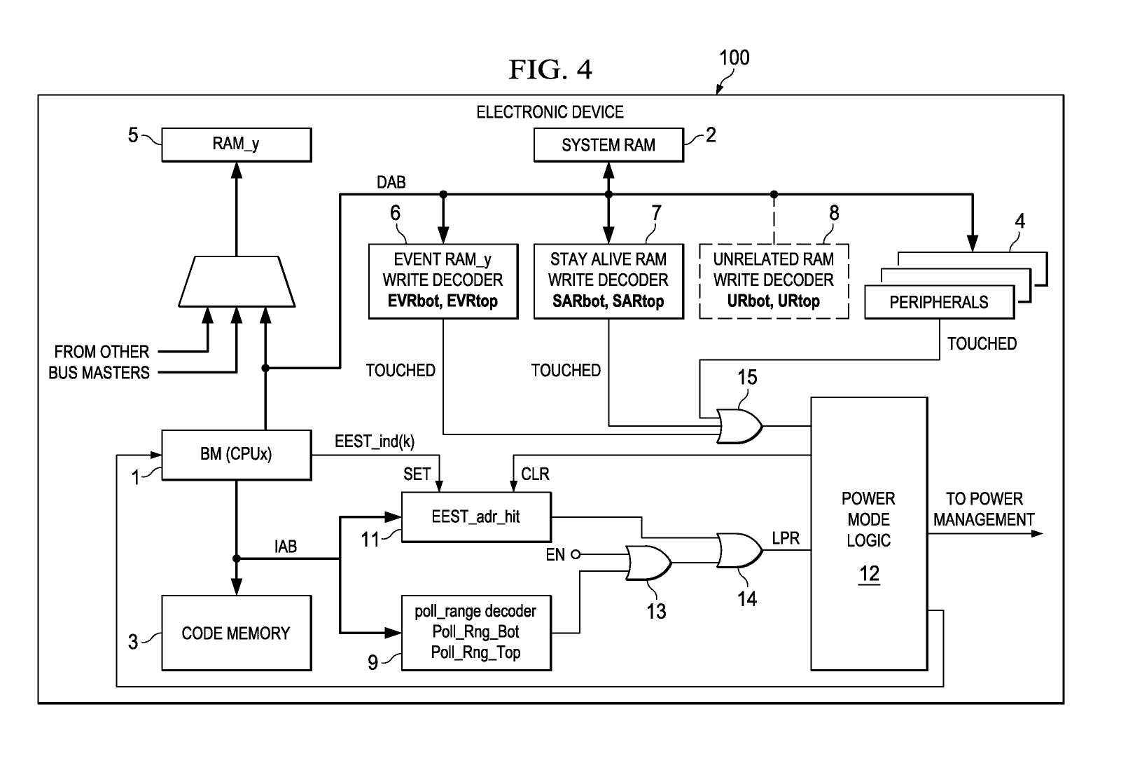

FIG. 4 shows a simplified block diagram and circuit diagram of an electronic device 100 according to an embodiment of the invention. There is an embedded microcontroller system comprising a bus master BM. This bus master is a central processing unit CPU 1 in this embodiment. There is further a system memory RAM 2 that contains data, code memory 3, and a set of peripherals 4. The embedded microcontroller system is inter-connected with address and data busses for instructions and data. Here only the data address bus DAB and instruction address bus IAB are shown. Furthermore, there is a sharable memory section RAM_y 5 that is configured to be used for event exchange in accordance with the aspects of the invention. There is also an event memory write decoder 6 for RAM_y 5, that features the register EVRbot (bottom address register) and EVRtop (top address register) and a stay alive RAM write decoder 7, that features the register SARbot (bottom address register) and SARtop (top address register) as well as an optional or implicit unrelated RAM write decoder 8 for formal completeness. The poll range address decoder 9 having registers Poll_Rng_Bot (bottom address register) and Poll_Rng_Top (top address register) is configured to monitor whether the address of an instruction lies within the polling range. This can be used as an alternative to the event indication instruction signal EEST_ind 10 from the CPU 1. The event indication instruction EEST_ind 10 is fed to an address hit logic 11 that is set with an address compare value or it contains a mask for checking the event indication instruction EEST_ind 10. Eventually, there is the power mode logic stage 12 that is coupled to receive signals from RAM decoder stages 6 and 7, peripherals 4 or the logic stage 11 or the polling range decoder through logic gates 13, 14 and 15. AND gate 13 implements an enabling mechanism for the polling range decoder 9. Or gate 14 is coupled to either pass the output from the instruction address hit logic 11 or the output (if enabled) from the polling range decoder to the power mode stage 12. OR-gate 15 is provided for gating the outputs of the event memory section RAM_y 6, stay alive memory section RAM 7 or the peripherals and passing the respective output signal to the power mode stage 12.

As soon as the CPU 1 executes an EEST_ind instruction the corresponding instruction address is latched inside the EEST address hit logic 11. When the EEST instruction is executed again at the same memory location a low power request LPR is signalized through OR-gate 14 to power mode stage 12. In response to the LPR request, the power mode stage 12 puts the system in low power mode. The power mode stage 12 is then sensitive to wake up signals received from the reserved event memory section RAM_y 5, stay alive memory section RAM 7 or peripherals 4. These signals arrive through OR-gate 15. Any write transactions to the event memory section RAM_y 5 generates a wake up request through RAM_y decoder 6 and OR-gate 15. The power mode stage 12 puts the system back in active mode and clears the EEST address hit logic 11 (EEST_adr_hit logic).

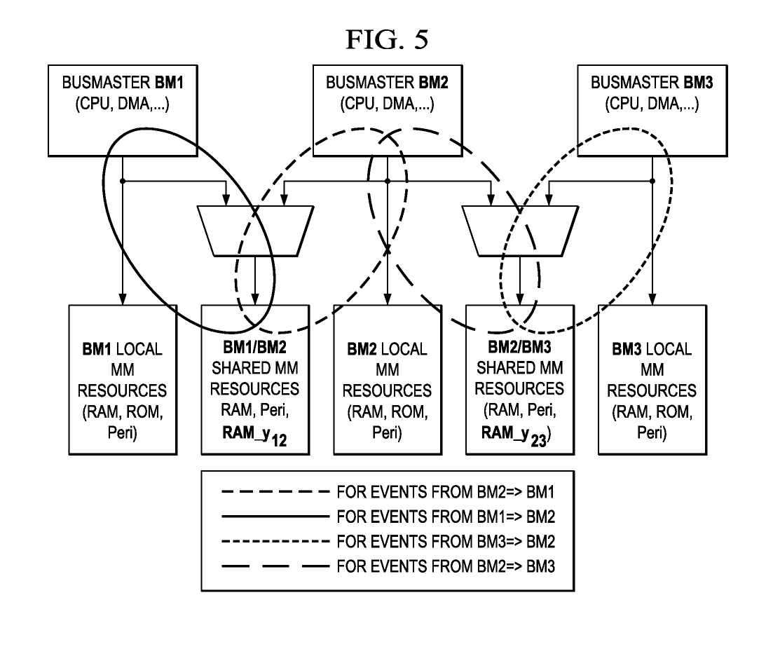

FIG. 5 shows a simplified diagram illustrating further aspects of the invention. The aspects of the invention can also be applied to distributed systems, an example of which is illustrated in FIG. 6. There are three bus masters BM1, BM2 and BM3. Each of the bus masters can be a central processing unit CPU, a direct memory access module DMA or any other bus master. Each bus master BM1, BM2 or BM3 is coupled to various resources that can be local or shared with other bus masters. The resources can be memory (RAM, ROM), peripherals or types of modules.

In this distributed system, the event indication instruction logic (polling stage; EEST logic) can be implemented multiple times depending on how many bus masters (BMs) are supposed to operate independently, while others remain in EEST supported polling loops. Any kind of bus master can be used. Direct memory access (DMA) controllers may be event sources that perform a memory write that wakes up the bus master that is the addressee of the event. Furthermore, it the kind of memory mapped resource (MM resource) used as reserved event memory section RAM_y is also irrelevant. It is also possible that peripherals are observed and used as event source. If an instance touches the resource with a write access, a wakeup can be started. Any event can trigger the wake up. For example a peripheral register might be seen as shared memory that can be written from the interior of the peripheral as “fictive bus master” as well as from any of the regular bus masters for wake up.

There are many different potential locations for the polling stages according to the invention. The location or event source can be the main bus—e.g. CPU data port or dedicated master module that has access to everything, high system activity. The polling stage can be coupled to the bus-slave inputs—e.g. memory controller, where it only has access to local memory (RAM and peripheral checker are usually sufficient). The polling stage can also be inside a peripheral bridge where it can be configured as a polling machine for module registers

Although the invention has been described hereinabove with reference to specific embodiments, it is not limited to these embodiments and no doubt further alternatives will occur to the skilled person that lie within the scope of the invention as claimed.

1. An electronic device comprising a bus master and a memory for storing a software program, the software program being configured to poll a status of a software and/or hardware module, wherein the electronic device is configured to enter a status polling loop and to leave the status polling loop for entering a low power mode when the electronic device executes the status polling loop a second time and to enter an active mode upon a write operation to a first predefined reserved address indicating that information related to the status of the software and/or hardware module arrived, wherein the electronic device comprises a polling stage for detecting that the status polling loop is executed a second time.

2. The electronic device according to claim 1, wherein the polling loop contains a dedicated event indication instruction for determining the second execution of the polling loop and the polling stage is configured to determine whether the dedicated instruction came from the same address or address range during the first and the second execution of the loop.

3. The electronic device according to claim 1, wherein the polling stage is configured to trigger the central processing unit to enter the low power mode if an instruction uses a reserved address.

4. The electronic device according to claim 1, wherein the polling stage is a state machine comprising a test-logic or compare-logic.

5. A method for event handling in an electronic device comprising a bus master and a memory for storing a software program, the method comprising the steps of:
polling a status of a software and/or hardware module in a polling loop, leaving the status polling loop and entering a low power mode when the the status polling loop is executed a second time, entering an active mode upon a write operation to a first predefined reserved address indicating that information related to the status of the software and/or hardware module arrived.
